(19) United States
(12) Patent Application Publication
(10) Pub. No.: US 2026/0192710 A1
(43) Pub. Date: Jul. 9, 2026

(54) Pivoting Base for a Vehicle Seat, in Particular of a Motor Vehicle, and Associated Seat and Motor Vehicle

(71) Applicant: SCOPEMA, Oradour Sur Vayres (FR)

(72) Inventors: Alexis Robert Maurice Lemesle, Limoges (FR); Fabian Xavier Noël Besson, Aixe Sur Vienne (FR)

(21) Appl. No.: 19/128,457

(22) PCT Filed: Nov. 15, 2023
(86) PCT No.: PCT/EP2023/081814

§ 371 Date: May 8, 2025

(30) Foreign Application Priority Data
Nov. 16, 2022 (FR) FR2211910

(51) Int. Cl. B60N 2/14

(52) U.S. Cl. CPC B60N 2/14

(57) ABSTRACT

This pivoting base, for a seat of a motor vehicle, in particular, a camping-car, comprises a first plate and a second plate, which are assembled to each other by means of a rotation device, in an assembled configuration of the pivoting base, where the plates provide a volume between them. The plates are respectively assembled to a vehicle floor and the seat by first and second fixing screws, which each comprise a threaded rod and a head. The thickness of the head of at least one screw, called flat-headed screw, among the first and second screws is less than 45% of a diameter of the rod of this screw.

This invention relates to a pivoting base for a vehicle seat, in particular a motor vehicle seat, a vehicle seat comprising such a pivoting base, as well as a motor vehicle comprising such a seat.

Certain vehicles, particularly recreational vehicles such as motorhomes, also known as “camping-cars” or “vans” in English, are generally equipped with seats mounted on a pivoting base, so that the seats can be turned at the choice of the user, depending on the circumstances. For example, the seat of the driver is turned toward the front of the vehicle during driving phases, while when the vehicle is stopped for camping, the seat of the driver is turned toward the rear of the vehicle.

A pivoting base comprises two plates, which are made of metal sheets and are mounted pivotally relative to each other by means of a bearing. One of the plates is fixed to the seat, whereas the other plate is fixed to the vehicle floor. The plates are fixed to the corresponding element, seat or floor, by means of reversible fastening members, generally screws or bolts. It is thus possible to equip a non-pivoting seat with a pivoting base, or to dismantle a defective base.

All the elements of a vehicle, and in particular each pivoting seat and the associated pivoting base, must present sufficient mechanical strength, to comply, in particular with safety standards in the event of an accident. Thus, the elements of the base, in particular, the plates and the fastening members of the plates, present minimum dimensions, which means that the base presents a certain bulk. However, pivoting bases are often mounted on existing seats, so it is desirable to minimize the dimensions of the pivoting bases, in order to not raise the vehicle seats too much. In particular, certain standards limit the seat elevation to 25 mm.

JP-2004/008443-A, AU-2006/100928-A4, and JP-2002/307987-A each describe prior art pivoting bases.

This invention aims, in particular, to address these problems by proposing a pivoting base for a vehicle seat that is both strong and presents reduced bulk.

To this end, the invention relates to a pivoting base for a seat of a motor vehicle, in particular a camping-car, the pivoting base comprising:
a first plate, which extends according to a first plane and is configured to be fixed to a vehicle floor by means of first fixing screws,
a second plate, which extends according to a second plane and is configured to be fixed to the seat by means of second fixing screws,
wherein:
the second plate is assembled to the first plate by means of a rotation device, in an assembled configuration of the pivoting base, where the second plate is maintained at a distance and facing the first plate, the first plane being parallel to the second plane, the second plate being guided in rotation relative to the first plate around a pivot axis orthogonal to the first plane, the first plate and the second plate providing a volume, located between them,
each of the first and second fixing screws comprises a threaded rod and a head, the rod of each screw extending according to a rod axis and being configured to pass through the respective plate, while the associated head is received in the volume located between them,
the head of each screw comprises a bearing face, which is configured to bear against the respective facing plate when the pivoting base is assembled to the seat or the floor, and an external face, opposite the bearing face,
the head of each screw presents a thickness, which is equal to a maximum of a distance, measured parallel to the rod axis, between the bearing face and the external face.

According to the invention, the thickness of the head of the at least one screw, called a flat-headed screw, from among the first and second screws, is less than 45% of a diameter of the rod.

Thanks to the invention, the fixing screws of the two plates present heads of reduced thickness, which allows the overall bulk of the pivoting base to be reduced. The fixing screws present less bulk while being strong, particularly resistant to tearing or shearing: the pivoting base presents a satisfactory level of safety in the event of an accident. The risks of interference between the heads of the flat-headed screws, whether during the pivoting of the pivoting base or when the vehicle is in motion and the base is subjected to dynamic forces, are reduced.

According to advantageous but non-mandatory aspects of the invention, such a pivoting base can incorporate one or more of the following features taken individually or according to any technically permissible combination:
For each flat-headed screw, the thickness is less than 38% of the rod diameter, preferably less than 31%.
For each flat-headed screw, the corresponding rod diameter is greater than or equal to 8 mm, preferably greater than or equal to 10 mm.
For the head of each flat-headed screw, the external face is parallel to the bearingface.
For each flat-headed screw, the head presents a cylindrical shape with a hexagonal section.
For each flat-headed screw, the head thickness is less than 4 mm, preferably less than 3.5 mm, preferably less than 3.0 mm.
The provided volume presents a height, measured parallel to the pivot axis, less than 19 mm, preferably less than 15 mm, preferably even less than 13 mm.

The invention also relates to a seat for a motor vehicle, the seat comprising a squab and a pivoting base as described above, wherein the seat is fixed to the second plate of the pivoting base.

The invention also relates to a motor vehicle, notably a camping-car, comprising the seat as described above, in which the first plate of the pivoting base is fixed to a floor of the motor vehicle.

The invention will be better understood, and other advantages thereof will appear more clearly in light of the following description of one embodiment of a pivoting base for a seat, a seat, and a motor vehicle, in accordance with its principle, given solely by way of example and made with reference to the appended drawings, in which:

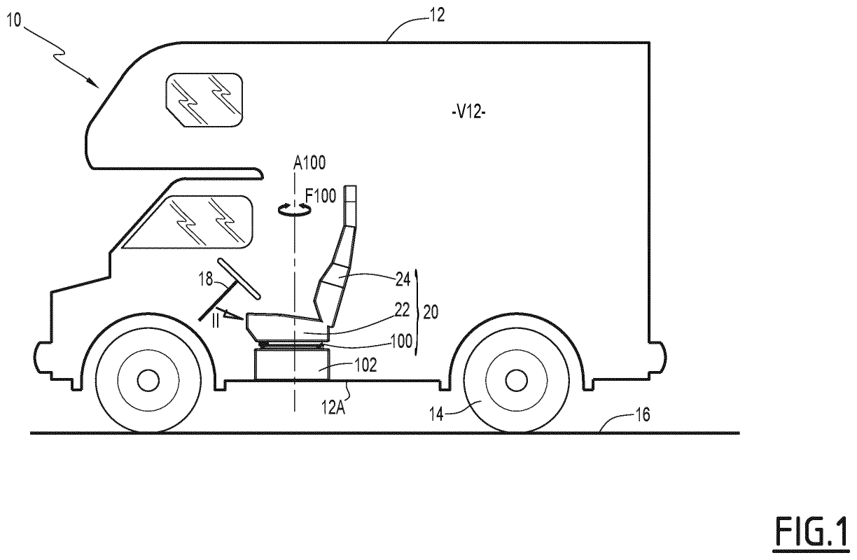

FIG. 1 is a longitudinal sectional view of a motor vehicle in accordance with the invention, comprising a seat mounted on a pivoting base, also in accordance with the invention;

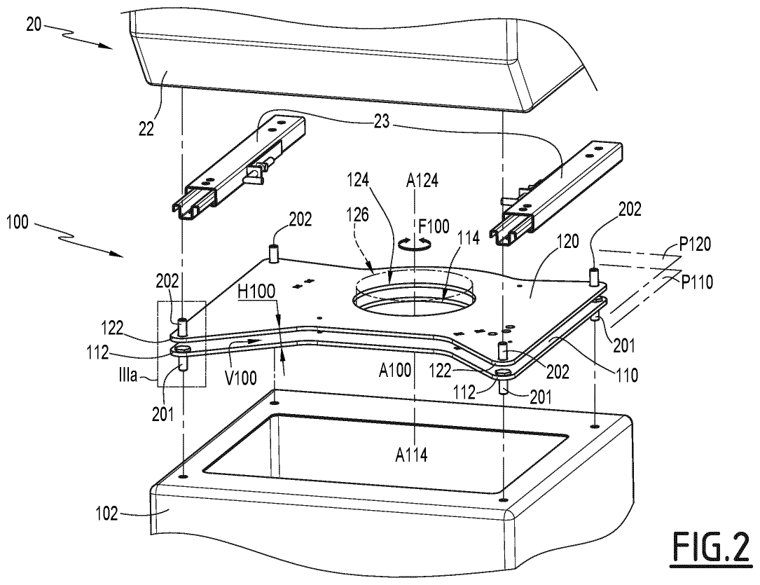

FIG. 2 is a partially exploded perspective view of the seat of FIG. 1, observed according to arrow II, and

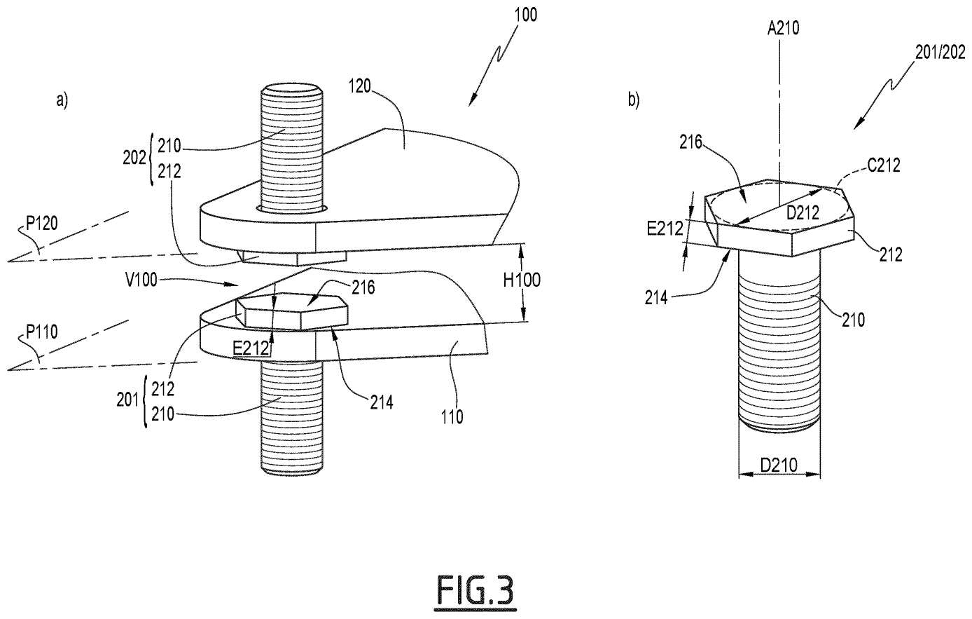

FIG. 3 respectively represents, on two inserts a) and b), a detail IIIa of the pivoting base of FIG. 2 and a part of the pivoting base.

A motor vehicle 10 is represented in FIG. 1. The motor vehicle 10 is here a camping-car. The motor vehicle 10, also simply called “the vehicle 10” in the context of the present description, comprises a body 12 that provides an internal volume V 12 intended to accommodate people, driver or passengers of the vehicle 10. The body 12 rests on wheels 14, which rest on the ground 16. The ground 16 is assumed to be horizontal, the following description being made in relation to the orientation of the various elements of the vehicle 10 as represented in the figures, knowing that it may be otherwise in reality.

The body 12 comprises a floor 12A, which extends parallel to the ground 16. The floor 12A is therefore horizontal here. The vehicle 10 is configured to move in a preferential direction, defining a forward direction of the vehicle 10. The forward direction is oriented to the left of FIG. 1. The vehicle 10 provides a driving position, schematically represented by a steering wheel 18, which is located on a front side of the vehicle 10. The front side of the vehicle 10 is located on the left of FIG. 1. A rear side of the vehicle 10 is a side opposite to the front side. The rear side of the vehicle 10 is here located on the right of FIG. 1.

The vehicle 10 comprises a seat 20, which is received in the internal volume V12 and is fixed to the body 12, the seat 20 being intended to accommodate a person in a sitting position. The seat 20 is here a seat of the driver, in other words, a seat arranged facing the steering wheel 18. In an alternative, not represented, the seat 20 is a passenger seat, for example, a seat adjacent to the driver, or even a seat located on a rear row relative to the seat of the driver.

The seat 20 comprises a squab 22, on which the driver sits, and a backrest 24. The seat 20 also comprises a pivoting base 100. The seat 20 is fixed to the floor 12A by means of the pivoting base 100, in an assembled configuration of the seat 20. In the assembled configuration of the seat 20, the squab 22 extends substantially parallel to the floor 12A.

The pivoting base 100, also simply called “the base 100” hereinafter, is fixed to the floor 12A by means of a plinth 102. The plinth 102 is schematically represented here and presents a generally parallelepiped shape. The plinth is used here to adjust the height of the squab 22 relative to the floor 12A. In an alternative, not represented, the plinth 102 is omitted, in which case the base 100 is fixed directly to the floor 12A.

With reference to FIG. 2, the base 100 comprises a first plate 110 and a second plate 120. The first plate 110 and the second plate 120 are each provided in a metal plate, preferably a steel plate, and are, for example, manufactured by cutting and/or stamping. The plates 110 and 120 are chosen to be sufficiently thick to mechanically withstand dynamic forces, particularly in the event of an accident or crash test, while remaining as thin as possible, to avoid unnecessary weight. Thus, in general, the first plate 110 and the second plate 120 each have a thickness between 3 mm and 6 mm. In the illustrated example, the first plate 110 and the second plate 120 each present a thickness equal to 5 mm.

The first plate 110 presents a substantially flat shape and extends according to a first plane P110. The first plate 110 is configured to be fixed to the floor 12A of the vehicle 10 by means of first screws 201. In the illustrated example, the first plate 110 is fixed to the floor 12A by means of the plinth 102 using the first screws 201.

The first plate 110 here presents a generally rectangular shape, with four corners 112, one of the first screws 201 being arranged near each of the corners 112 of the first plate 110. The shape of the first plate 110 is not limiting. Alternatively, the first plate 110 presents a trapezoidal shape.

The first plate 110 provides a first opening 114. The first opening 114 is located substantially at the barycenter of the four corners 112 and presents a circular contour centered on a first axis A114, which is orthogonal to the first plane P110. Alternatively, the first opening 114 is offset relative to the barycenter of the four corners 112, to benefit from the offset during and/or at the end of the rotation of the seat 20.

The second plate 120 presents a substantially flat shape and extends according to a second plane P120. The second plate 120 is configured to be fixed to the squab 22 by means of second screws 202. In the illustrated example, the second plate 120 is fixed to the squab 22 by means of optional slides 23. Alternatively, not illustrated, the slides 23 are omitted, and the second plate 120 is directly fixed to the squab 22 by means of the second screws 202. According to another alternative, not illustrated, the first plate 110 is fixed to the floor 12A by means of the slides 23, in other words, the slides 23 are interposed between the pivoting base 100 and the floor 12A.

The second plate 120 presents here a generally rectangular shape, with four corners 122, one of the second screws 201 being arranged near each of the corners 122 of the second plate 120. The shape of the second plate 120 is not limiting. Alternatively, the second plate 120 presents a trapezoidal shape. Preferably, the second plate 120 is similar to the first plate 110. Preferably still, the second plate 120 is identical to the first plate 110. What is valid for the first plate 110 is transposable to the second plate 120.

The second plate 120 provides a second opening 124. The second opening 124 has a circular shape centered on a second axis A124, which is orthogonal to the second plane P120.

The second plate 120 is assembled to the first plate 110 by means of a rotation device 126, in an assembled configuration of the pivoting base 100, wherein the second plate 120 is maintained at a distance from and facing the first plate 110, the first plane P110 being parallel to the second plane P120, the second plate 120 being guided in rotation relative to the first plate 110 according to a movement in rotation F100 around a pivot axis A100 orthogonal to the first plane P110. The rotation device 126 is schematically represented in FIG. 2 by a cylinder in dotted lines. The movement in rotation F100 is represented, in FIGS. 1 and 2, by a circular double arrow centered on the pivot axis A100.

The rotation device 126, which belongs to the pivoting base 100, is for example a bearing, in particular, a sliding bearing, which is received in the first and second openings 114 and 124. The pivot axis A100 is thus coincident with the first and second axes A114 and A124.

The pivoting base 100 generally comprises a locking device, which is controlled by a user and serves to selectively block an angular position of the first plate 110 relative to the second plate 120 around the pivot axis A100, so as to avoid unintended movement in rotation F100 of the pivoting base. The locking device is not represented.

In the assembled configuration of the pivoting base 100, the first plate 110 and the second plate 120 provide between them a volume V100. The volume V100 presents a height H100, which is measured parallel to the pivot axis A100. When the pivoting base 100 is interposed between the seat 20 and the floor 12A, this seat 20 is raised by a height substantially equal to the sum of the thicknesses of the first and second plates 110 and 120, and the height H100 of the volume V100 between them. The maximum height H100 of the volume V100 is, in particular, chosen depending on the thicknesses of the first and second plates 110 and 120, in such a way as to comply with various regulatory constraints, in particular so that the elevation of the seat 20 remains less than 25 mm.

When the thickness of the first and second plates 110 and 120 is equal to 3 mm, the height H100 of the volume V100 between them is chosen to be less than 19 mm. When the thickness of the first and second plates 110 and 120 is equal to 6 mm, the height H100 of the volume V100 between them is chosen to be less than 13 mm. In the illustrated example, the first and second plates 110 and 120 each have a thickness equal to 5 mm, thus the height H100 of the volume V100 between them is less than 15 mm. The height H100 of the volume V100 between them is here equal to 12 mm. According to other examples, the height H100 of the volume V100 between them is equal to 13 mm. More generally, the height H100 of the volume V100 between them is less than 19 mm, preferably less than 15 mm, preferably even less than 13 mm. The pivoting base 100 is thus particularly compact.

Each of the first and second screws 201 and 202 comprises a rod 210 and a head 212. Each rod 210 is threaded, presents a diameter D210, and extends according to a rod axis A210.

In the assembled configuration of the pivoting base 100 to the seat 20, the rod 210 of each second screw 202 passes through the second plate 120, while the head 212 associated with this rod 210 is received in the volume V100 between them. Similarly, in the assembled configuration of the pivoting base 100 to the floor 12A, the rod 210 of each first screw 201 passes through the first plate 110, while the head 212 associated with this rod 210 is received in the volume V100 between them.

Each head 212 thus comprises a bearing face 214, which is oriented on the side of the corresponding rod 210 and is configured to bear against the facing plate 110 or 120. Each head 212 also comprises an external face 216, which is oriented opposite the bearing face 214. Each head 212 presents a thickness E 212, which is equal to a maximum of a distance, measured parallel to the rod axis A210, between the bearing face 214 and the external face 216.

In the figures, the first and second plates 110 and 120 are represented in a so-called “forward” orientation, which corresponds to the seat 20 oriented towards the front of the vehicle 10. By extension, the pivoting base 100 is said to be in a forward configuration. In this forward configuration, the external face 216 of each first screw 201 is located facing the external face 216 of a second screw 202. It is understood that during the movements in rotation F 100 of the base 100, particularly when the seat 20 is turned while a person is sitting on this seat 20, the heads 212 of the first and second screws 201 and 202 may come closer, or even collide, which is not desirable.

To this end, the thickness E212 is less than 45% of the diameter D210 of the rod 210, preferably less than 38%, preferably less than 31%.

Thus, the first screws 201 and second screws 202, which present a head 212 of reduced thickness relative to the diameter D210 of the rod 210, are also called “flat-headed screws.”

The thickness of the first and second plates 110 and 120, as well as the diameters D210 of the rods 210, are, in particular, chosen depending on the type of seat 20 that the pivoting base 100 supports. In general, the rods 210 have a diameter D210 between 8 mm and 12 mm. Thus, the diameter D210 of the rod 210 is greater than or equal to 8 mm, preferably greater than or equal to 10 mm.

In the illustrated example, the diameter D210 of each rod 210 is equal to 8 mm.

Preferably, the thickness E212 of each head 212 is less than 4 mm, preferably less than 3.5 mm, preferably less than 3.0 mm. This thus avoids the risks of interference between the heads 212 of the first and second screws 201 and 202, for example during the movements in rotation F100 of the pivoting base 100, or while the vehicle 10 is in motion and the first and second screws 201 and 203 are facing each other, when the plates 110 and 120 flex under the effect of transient forces and accelerations generated by the movement of the vehicle 10.

Preferably, the external face 216 is flat and extends parallel to the bearing face 214. In other words, the head 212 presents a constant thickness E212.

For each head 212, a diameter D212 of this head is defined as being a diameter of a circle C212 inscribed in a contour of this head 212. Each head 212 here presents a cylindrical shape with a hexagonal section.

The bearing surface 214 is as extensive as possible, so as to distribute the forces between the bearing face 214 and the facing plate 110 or 120. Thus, for each flat head 212, the diameter D212 is greater than 160% of the diameter D210 of the rod associated with this flat head 212, preferably greater than 170%, preferably even greater than 180%. In the illustrated example, the diameter D210 of the rods 210 is equal to 8 mm, while the diameter D212 of the associated flat head 212 is equal to 162% of the diameter D210 of the rods 210. According to an alternative, not illustrated, the diameter D210 of the rods 210 is equal to 10 mm, while the diameter D 212 of the associated flat head 212 is equal to 170% of the diameter D210 of the rods 210.

Advantageously, the first screws 201 and the second screws 202 are identical to each other.

In an alternative, not represented, some of the screws used to fix the first plate 110 to the floor 12A are of a different type from the first screws 201. Similarly, in an alternative, not represented, some of the screws used to fix the second plate 120 to the seat 20 are of a different type from the second screws 202.

More generally, the pivoting base 100 comprises at least one flat-headed screw, which is to say, at least one screw of the type of the first screws 201 or the second screws 202.

The embodiments and alternatives mentioned above can be combined with each other to generate new embodiments of the invention.

1-9. (canceled)

10. A pivoting base for a seat of a motor vehicle, the pivoting base comprising:
a first plate, which extends according to a first plane and is configured to be fixed to a floor of the vehicle by means of first fixing screws; and
a second plate, which extends according to a second plane and is configured to be fixed to the seat by means of second fixing screws;
wherein:
the second plate is assembled to the first plate by a rotation device such that, in an assembled configuration of the pivoting base, the second plate is maintained at a distance and facing the first plate, the first plane being parallel to the second plane, the second plate being guided in rotation relative to the first plate around a pivot axis orthogonal to the first plane, and the first plate and the second plate providing a volume between them;
each of the first and second fixing screws comprises a threaded rod and a head, the rod of each screw extending according to a rod axis and being configured to pass through the respective plate, whereas the associated head of each screw is received in the volume between the first plate and the second plate;
the head of each screw comprises a bearing face and an external face opposite the bearing face, wherein the bearing face is configured to bear against the respective plate when the pivoting base is assembled to the seat or the floor;
the head of each screw has a thickness, which is equal to a maximum of a distance, measured parallel to the rod axis, between the bearing face and the external face; and
at least one of the first and second fixing screws is a “flat-headed” screw, wherein the thickness of the head is less than 45% of a diameter of the rod.

11. The pivoting base according to claim 10, wherein, for each flat-headed screw, the thickness of the head is less than 38% of the diameter of the rod.

12. The pivoting base according to claim 10, wherein, for each flat-headed scree, the thickness of the head is less than 31% of the rod.

13. The pivoting base according to claim 10, wherein, for each flat-headed screw, the diameter of the corresponding rod is greater than or equal to 8 mm.

14. The pivoting base according to claim 10, wherein, for each flat-headed screw, the diameter of the corresponding rod is greater than or equal to 10 mm.

15. The pivoting base according to claim 10, wherein, for each flat-headed screw, the external face is parallel to the bearing face.

16. The pivoting base according to claim 10, wherein, for each flat-headed screw, the head has a cylindrical shape with a hexagonal section.

17. The pivoting base according to claim 10, wherein, for each flat-headed screw, the thickness of the head is less than 4 mm.

18. The pivoting base according to claim 10, wherein, for each flat-headed screw, the thickness of the head is less than 3.5 mm.

19. The pivoting base according to claim 10, wherein, for each flat-headed screw, the thickness of the head is less than 3.0 mm.

20. The pivoting base according to claim 10, wherein the volume between the first plate and the second plate has a height, measured parallel to the pivot axis, that is less than 19 mm.

21. The pivoting base according to claim 20, wherein the height of the volume between the first plate and the second plate is less than 15 mm.

22. The pivoting base according to claim 20, wherein the height of the volume between the first plate and the second plate is less than 13 mm.

23. A seat for a motor vehicle, the seat comprising a squab and a pivoting base according to claim 10, wherein the squab is fixed to the second plate of the pivoting base.

24. A motor vehicle comprising a seat according to claim 23, wherein the first plate of the pivoting base is fixed to a floor of the motor vehicle.
